(19) United States
(12) Patent Application Publication
(10) Pub. No.: US 2003/0072160 A1
(43) Pub. Date: Apr. 17, 2003

(54) Reflector for a high pressure gas discharge lamp

(76) Inventors: Thomas Kuepper, Bad Gandersheim (DE); Rolf Meyer, Bad Gandersheim (DE)

Correspondence Address: STRIKER, STRIKER & STENBY, 103 East Neck Road, Huntington, NY, 11743, US

(21) Appl. No.: 10/267,326

(22) Filed: Oct. 9, 2002

(30) Foreign Application Priority Data
Oct. 13, 2001 (DE) 101 50 656.2

(51) Int. Cl. F21V 7/00

(52) U.S. Cl. 362/263; 362/296; 362/350; 362/518

(57) ABSTRACT

The reflector for a light, which has a high-pressure gas discharge lamp, has an adherent polymeric coating extending over at least a portion of its outer surface. This polymeric coating contains at least one fluoro-polymer. The coating thickness is from 5 μm to 200 μm. A method of making the polymeric coating on the outer surface of the reflector includes powder coating the outer surface of the reflector with the at least one fluoro-polymer and subsequently heat after-treating the reflector with the powder coated outer surface. Alternatively the reflector is coated in a dipping or spraying process and then thermally after-treated. The coated reflector can be used in a headlight or an optical device for projecting data.

### BACKGROUND OF THE INVENTION

1. Field of the Invention

The present invention relates to a reflector for a high power light, which comprises a base body made of glass or glass-ceramic, which has a neck-shaped receptacle for a high pressure gas discharge lamp, and has an outer surface and an interior surface facing the gas discharge lamp.

2. Description of the Related Art

The term “light” in general means a device for holding and operating a man-made light source (gas discharge lamp, etc). The invention involves those lights, which have an optical reflector for a desired light distribution, such as lights for the home, lights for supply of light to a light guide, automobile headlights, projectors, etc. Reflectors of this sort usually have an elliptical, parabolic or cone-shaped cross-section and typically are made from glass or glass-ceramic. Furthermore they have a so-called cold light coating, with which the visible radiation of the built-in lamp is reflected but the IR radiation passes through, whereby the reflector has a colored residual transmission toward the exterior, appearing mostly bluish, but also reddish, greenish or some other color.

Reflectors of this type are widely used in the lighting industry, especially in the form of a freely suspended halogen radiator for room lighting. Lamps of this type have a relative small electrical power consumption of 10 to 60 watts.

However there are also lighting units with reflectors, which require light sources of higher electrical power, for example digital projection devices, which include the so-called beamers, headlights, etc. The power that they require is in a range from 300 to 400 watts. A gas discharge lamp is typically used as a light source for this sort of light with a reflector. This gas discharge lamp has a high internal pressure of up to 2×10⁵ hPa. They have numerous technological advantages, however thermo-chemical effects limit their service life. Generally their service life or lifetime is on the order of about 2000 hours.

The invention especially concerns reflectors of the sort for this type of light of higher power.

A serious disadvantage of this type of gas discharge lamp is that they self-destruct by explosion at the end of their service life. Their explosion seriously damages these reflectors, whereby glass or glass-ceramic splinters or pieces from them fly around and cause considerable danger. Furthermore these explosions can damage valuable optical components and components of this sort of lighting unit.

To avoid the splintering of the glass or glass-ceramic reflectors they are made with comparatively great wall thickness. The wall thickness of these reflectors is more than 4 mm. Thermal stresses caused by the high heat load can lead to breakage. The increased wall thickness is thus not a satisfactory solution to the problem.

### SUMMARY OF THE INVENTION

It is an object of the present invention to provide a reflector of the above-described kind, which at least reduces and preferably completely prevents damage to optical components and parts of a lighting apparatus including the reflector and a gas discharge lamp mounted in the reflector, in the event that the gas discharge lamp bursts or explodes.

It is another object of the present invention to provide a method of making the reflector of the present invention, which reduces or prevents damage to optical components and parts of a lighting apparatus including the reflector and a gas discharge lamp mounted in the reflector, in the event that the gas discharge lamp bursts or explodes, which method is an economical and environmentally friendly process.

This object and others, which will be made more apparent hereinafter, are attained in a reflector for a high power light, the reflector comprising a glass or glass-ceramic base body, which has a neck-shaped receptacle for a high-pressure gas discharge lamp and which has an outer surface as well as an interior or inner surface facing the high pressure gas discharge lamp when the gas discharge lamp is mounted in the neck-shaped receptacle of the reflector.

According to the invention the outer surface of the reflector is provided with an adherent polymeric coating extending over at least a portion of its outer surface, and the polymeric coating contains at least one polymer.

According to the invention a reflector of the above-described type is provided with an outer polymeric coating, a protective jacket or layer. This polymeric coating comprises a polymer, which resists high temperatures and which forms an adherent layer, which extends over at least a part of the reflector outer surface. However the entire reflector outer surface does not need to be covered with the polymeric layer. It can also be sufficient to provide the polymeric layer over a required portion of the reflector surface—as seen in the axial direction of the reflector.

Particularly in a preferred embodiment the at least one polymer used to coat the outer surface of the reflector is a fluoro-polymer. Fluoro-polymers have an especially high heat resistance. The glass or glass-ceramic splinters or pieces generated when the gas discharge lamp mounted in the reflector bursts or explodes are reliably prevented from flying around by the fluoro-polymer coating on the outer surface of the reflector. The fluoro-polymer layer can withstand the greatest explosion pressures.

The original cold light functioning of the reflector, namely the lateral guiding of infrared radiation, is in no way impaired by the fluoro-polymer layer. The so-called cold light reflector so named because of this function can be employed, as previously provided, so that in the case of an explosion no splinters or pieces fly around and the other optical components and parts are not damaged. The exteriorly coated cold-light reflector thus has considerable economic significance.

In preferred embodiments of the invention the polymer coating has a thickness of 5 μm to 200 μm, preferably from 50 μm to 180 μm and especially preferably from 80 μm to 170 μm. A coating of preferably from 35 μm to 50 μm is sufficient in regions of the reflector, which are not endangered by explosion. In regions of the reflector, which are endangered by explosion, the coating thickness is preferably from 120 μm to 170 μm. The neck of the reflector is preferably left uncoated, i.e. no polymer coating is provided in the neck of the reflector.

In a preferred method for making the reflector with the coated outer surface the reflector is powder-coated layer-wise with the at least one polymer and then thermally after-treated. Alternatively the reflector may be coated with the polymer in a dipping or spraying process and then thermally after-treated.

According to the invention the polymer-coated reflector may be used in a projection unit and in valuable optical devices for projecting data, a headlight or a searchlight and in other lighting apparatus.

### BRIEF DESCRIPTION OF THE SEVERAL VIEWS OF THE DRAWING

The objects, features and advantages of the invention will now be illustrated in more detail with the aid of the following description of the preferred embodiments, with reference to the accompanying figures in which:

FIG. 1 is a front view of a preferred embodiment of a reflector according to the invention which is coated with a polymeric coating over a portion of its outer surface; and

FIG. 2 is a cross-sectional view through the coated reflector shown in FIG. 1 taken along the section line A-A in FIG. 1.

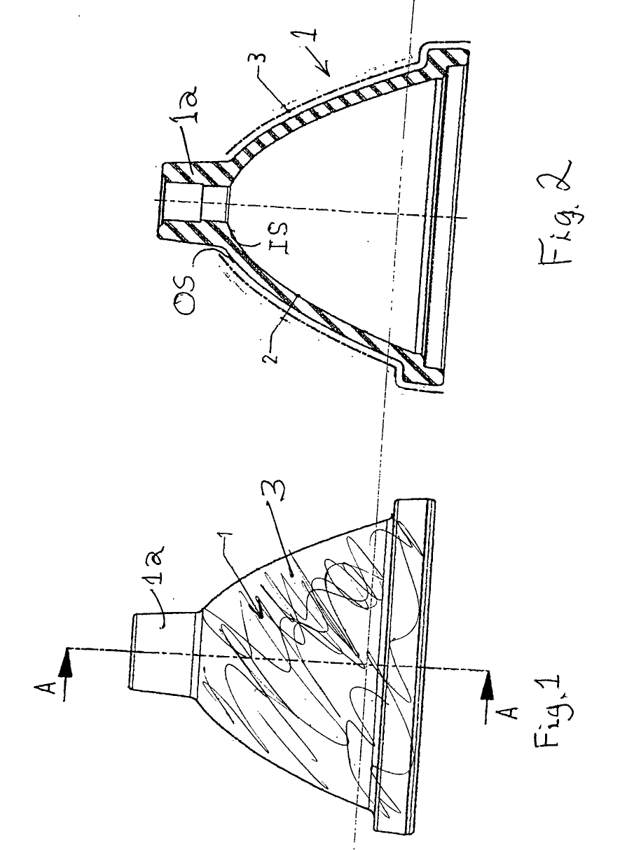

### DETAILED DESCRIPTION OF THE INVENTION

FIG. 2 shows a longitudinal section through the reflector 1 for a light. The reflector 1 comprises a glass or glass-ceramic base body 2, which has a typically parabolic shape with a reflective inner surface. This reflector 1 can be equipped with an unshown high-pressure gas discharge lamp. In high power lights the high-pressure gas discharge lamp is mounted in a receptacle 1a of the reflector 1.

As described above, at the end of the service life of the light an explosion destroys the gas discharge lamp and the base body 2 of the reflector 1 is damaged. Without the adherent polymeric coating 3 the resulting glass or glass-ceramic splinters or pieces from the base body 2 would fly around. These splinters or pieces would damage valuable optical components and parts of the unit.

In order to prevent breaking apart of the base body 2 of the reflector and glass or glass-ceramic splinters or pieces from reaching the respective optical components, the reflector 1 is provided with an adherent polymeric coating 3 extending over at least a portion of the outer surface OS of the base body 2. The polymer or polymers, preferably a fluoro-polymer, that form the polymeric coating 3 is or are applied directly to the base body 2. In the embodiment shown in the figures the polymeric coating 3 extends over the entire outer surface OS of the base body 2, with the exception of a residual portion of the outer surface on the receptacle 1a in the neck region of the base body 2. The inner surface OS is not coated with this polymeric coating.

The protective jacket formed by the polymeric coating 3 prevents pieces of the base body flying around when the base body is destroyed by explosion at the end of the service life of the light.

The disclosure in German Patent Application 101 50 656.2-23 of Oct. 13, 2001 is incorporated here by reference. This German Patent Application describes the invention described hereinabove and claimed in the claims appended hereinbelow and provides the basis for a claim of priority for the instant invention under 35 U.S.C. 119.

While the invention has been illustrated and described as embodied in a reflector for a high pressure gas discharge lamp, it is not intended to be limited to the details shown, since various modifications and changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and is set forth in the following appended claims.

We claim:

1. A reflector (1) for a high power light, the reflector comprising a glass or glass-ceramic base body (2), said base body including a neck-shaped receptacle (1a) for a high-pressure gas discharge lamp and having an outer surface (OS) as well as an interior surface (IS), said interior surface facing the high pressure gas discharge lamp when said high pressure gas discharge lamp is arranged in said neck-shaped receptacle;
wherein the outer surface (OS) of the reflector is provided with an adherent polymeric coating (3) extending over at least a portion of said outer surface, said adherent polymeric coating (3) containing at least one polymer.

2. The reflector as defined in claim 1, wherein said polymeric coating (3) contains at least one fluoropolymer.

3. The reflector as defined in claim 1, wherein said polymeric coating (3) has a coating thickness of 5 μm to 200 μm.

4. The reflector as defined in claim 3, wherein said coating thickness is from 50 μm to 180 μm.

5. The reflector as defined in claim 4, wherein said coating thickness is from 80 μm to 170 μm.

6. The reflector as defined in claim 1, wherein a residual portion of said outer surface on said neck-shaped receptacle (1a) is not coated with said at least one polymer.

7. A method of making a coated reflector (1), said coated reflector (1) comprising a glass or glass-ceramic base body (2), wherein said base body includes a neck-shaped receptacle (1a) for a high-pressure gas discharge lamp and has an outer surface (OS) as well as an interior surface (IS), said interior surface facing the high pressure gas discharge lamp when said high pressure gas discharge lamp is arranged in said neck-shaped receptacle (1a) and said outer surface (OS) of the reflector (1) is provided with an adherent polymeric coating (3) extending over at least one portion of said outer surface, said polymeric coating (3) containing at least one polymer; wherein said method comprises the steps of:
a) powder coating said at least one portion of said outer surface of the reflector with said at least one polymer; and
b) after the powder coating of step a), thermally after-treating the reflector coated with the at least one polymer.

8. A method of making a coated reflector (1), said coated reflector (1) comprising a glass or glass-ceramic base body (2), wherein said base body includes a neck-shaped receptacle (1a) for a high-pressure gas discharge lamp and has an outer surface (OS) as well as an interior surface (IS), said interior surface facing the high pressure gas discharge lamp when said high pressure gas discharge lamp is arranged in said neck-shaped receptacle (1a) and said outer surface (OS) of the reflector (1) is provided with an adherent polymeric coating (3) extending over at least one portion of said outer surface, said polymeric coating (3) containing at least one polymer; wherein said method comprises the steps of:
a) coating said at least one portion of said outer surface of the reflector with said at least one polymer by means of a dipping or spraying process; and
b) after the coating of step a), thermally after-treating the reflector coated with said at least one polymer.

9. A projection headlight, said projection headlight comprising a coated reflector (1), said coated reflector (1) comprising a glass or glass-ceramic base body (2), wherein said base body includes a neck-shaped receptacle (1a) for a high-pressure gas discharge lamp and has an outer surface (OS) as well as an interior surface (IS), said interior surface facing the high pressure gas discharge lamp when said high pressure gas discharge lamp is arranged in said neck-shaped receptacle (1a) and said outer surface (OS) of the reflector (1) is provided with an adherent polymeric coating (3) extending over at least one portion of said outer surface, said polymeric coating (3) comprising at least one polymer.

10. An optical apparatus for data projection, said optical apparatus comprising a coated reflector (1), said coated reflector (1) comprising a glass or glass-ceramic base body (2), wherein said base body includes a neck-shaped receptacle (1a) for a high-pressure gas discharge lamp and has an outer surface (OS) as well as an interior surface (IS), said interior surface facing the high pressure gas discharge lamp when said high pressure gas discharge lamp is arranged in said neck-shaped receptacle (1a) and said outer surface (OS) of the reflector (1) is provided with an adherent polymeric coating (3) extending over at least one portion of said outer surface, said polymeric coating (3) comprising at least one polymer.
